(19) United States
(12) Patent Application Publication
(10) Pub. No.: US 2014/0060262 A1
(43) Pub. Date: Mar. 6, 2014

(54) WRENCH

(71) Applicant: Chang Hsueh-O Hsu, (US)

(72) Inventor: Chang Hsueh-O Hsu, (US)

(21) Appl. No.: 13/597,260

(22) Filed: Aug. 29, 2012

(51) Int. Cl. B25B 13/26

(52) U.S. Cl. 81/129

(57) ABSTRACT

A wrench includes a main body with a fixed jaw and a sliding slot, a jaw portion, and a handle with a toggle element. The jaw portion has a movable jaw wherein a bottom of the movable jaw forms a sliding portion forming a restricting recess. A contact surface between a bottom of the sliding portion and a bottom of the sliding slot defines an interface wherein an extension of the interface traverses the restricting recess. When the handle is at a driving position, the toggle element abuts against the sliding portion, and the extension of the interface traverses the toggle element. When the handle is at a release position, the movable jaw is able to move away from the fixed jaw. Thereby, the pulling force from a user can be fully transmitted to the movable jaw and the fixed jaw.

### BACKGROUND OF THE INVENTION

1. Field of the Invention

The present invention relates to a wrench.

2. Description of the Prior Art

A conventional wrench functions by engagement of two toothed portions formed on a movable jaw and on a handle respectively. However, due to the torque exerted to the wrench, the toothed portions are possible to be damaged or abraded.

To solve the problem, U.S. Pat. No. 1,434,754 provides an innovative wrench. The wrench has a spring disposed in a receiving groove, and a fixing pin is inserted through a body and the receiving groove. The wrench has a protrusion below the receiving groove and a toggle element in a restricting recess below the receiving groove. Most of the force exerting to the movable jaw by the toggle element is borne by the protrusion. The toggle element extends outward obliquely from a top of the handle, but the protrusion extends obliquely toward the restricting recess. Thus, the toggle element and the protrusion have opposite extending directions so that the toggle element can abut against the protrusion just by point contact. Also, the toggle element abuts against the protrusion obliquely, so only part of force is used for pushing the protrusion horizontally. In other words, though the wrench has no engagement between toothed portions, the wrench is still difficult to be operated as a result of that only part of force is transmitted to the movable jaw and the fixed jaw.

Besides, the movable jaw and the fixed jaw are positioned by two plates, so two receiving grooves and two fixing pins are needed. The wrench is assembled by inserting the two fixing pins through the movable jaw, the fixed jaw, and the receiving grooves, so the structure is too complicated.

### SUMMARY OF THE INVENTION

The main object of the present invention is to provide a wrench which is easy to operate and has a simple structure.

To achieve the above and other objects, a wrench of the present invention includes a main body, a jaw portion, a handle, and an elastic element.

The main body is formed in one piece and forms a fixed jaw at an end. The main body further forms a sliding slot along a first direction which is substantially perpendicular to an extending direction of the fixed jaw.

The jaw portion integrally forms a movable jaw at an end and a sliding portion at a bottom of the movable jaw. The sliding portion forms at least a restricting recess and is slidably disposed in the sliding slot. A jaw opening is defined between the movable jaw and the fixed jaw. An interface is defined by a contact surface between a bottom of the sliding portion and a bottom surface of the sliding slot away from the fixed jaw. An extension of the interface traverses the restricting recess.

The handle is rotatably disposed on the main body. The handle has at least one toggle element at an end, and the toggle element extends into the restricting recess. The handle is able to pivot between a driving position and a release position. When the handle is at the driving position, the toggle element abuts against the sliding portion to retain the jaw opening in a minimum size. When the handle is at the release position, the movable jaw is able to move away from the fixed jaw to enlarge the jaw opening.

The elastic element is disposed between the main body and the jaw portion and provides an elastic force so that the movable jaw tends to move toward the fixed jaw.

Thereby, the wrench of the present invention is able to fully transmit the force exerted by a user to the movable jaw and the fixed jaw. Thus, the wrench of the present invention is easy to be operated and has a simple structure to reduce manufacturing cost.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing showing a first embodiment of the present invention;

FIG. 2 is a stereogram showing a first embodiment of the present invention;

FIG. 3 is a profile showing a first embodiment of the present invention;

FIG. 4 is a profile during operation showing a first embodiment of the present invention;

FIG. 5 is a profile showing a second embodiment of the present invention;

FIG. 6 is a profile showing a third embodiment of the present invention;

FIG. 7 is a profile showing a fourth embodiment of the present invention.

### DETAILED DESCRIPTION OF THE PREFERRED EMBODIMENTS

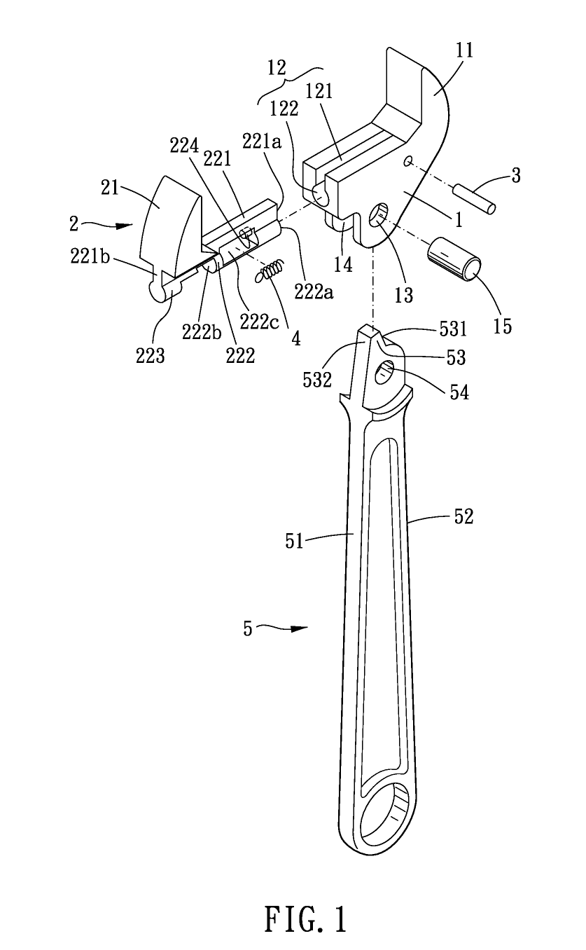

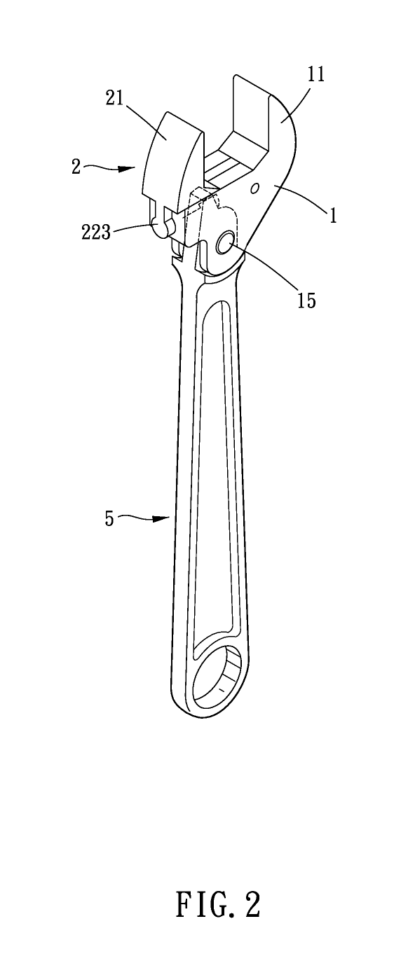

Please refer to FIG. 1 to FIG. 3 for a first embodiment of the present invention. The wrench of the present invention includes a main body 1, a jaw portion 2, an abutting element 3, an elastic element 4, and a handle 5.

The main body is formed in one piece and forms a fixed jaw 11 at an end. The main body 1 further forms a sliding slot 12 along a first direction which is substantially perpendicular to an extending direction of the fixed jaw 11. Besides, the main body 1 also forms a through hole 13 and a trough 14. The sliding slot 12, the through hole 13, and the trough 14 communicate with each other wherein the through hole 13 is located between the sliding slot 12 and the trough 14. In addition, an axial direction of the through hole 13 is perpendicular to the first direction. In view of the sliding slot 12, the sliding slot 12 includes a first slot 121 and a second slot 122 penetrating the main body 1. A sliding axis A is defined by an extending direction of the sliding slot 12 and is perpendicular to the first direction. More preferably, the first slot 121 has a width smaller than a width of the second slot 122.

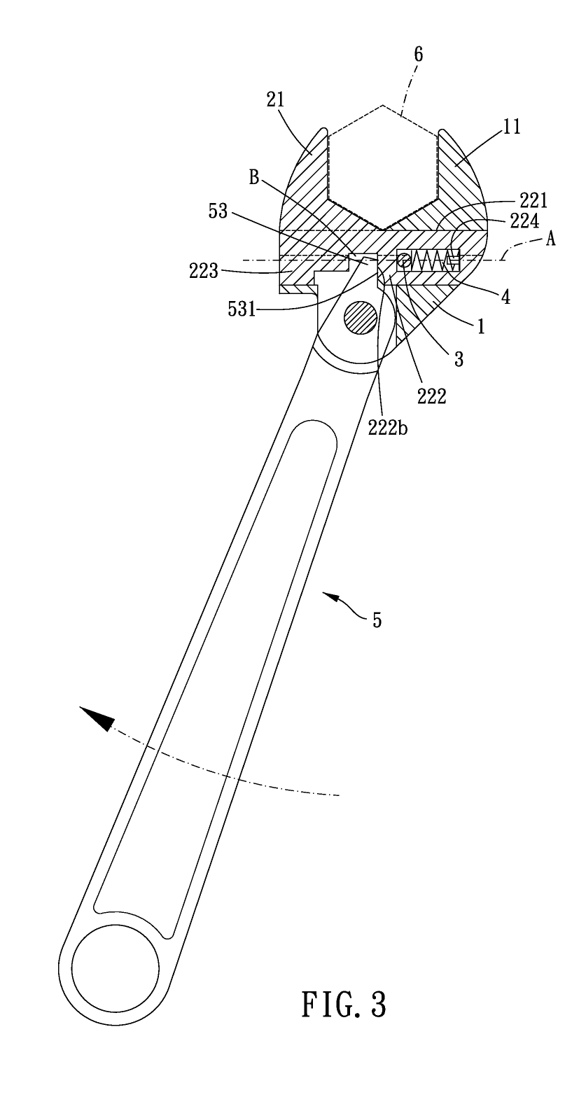

The jaw portion 2 integrally forms a movable jaw 21 at an end of the jaw portion 2 and a sliding portion at a bottom of the movable jaw 21. The sliding portion is slidably disposed in the sliding slot 12 and forms at least one restricting recess B. A jaw opening is defined between the movable jaw 21 and the fixed jaw 11. A size of the jaw opening is changed when the sliding portion moves. The jaw opening is adapted for clamp a nut 6, a screw, or other analogous objects, as shown in FIG. 3. A sliding direction of the sliding portion is parallel to the first direction. An interface is defined by a contact surface between a bottom of the sliding portion and a bottom surface of the sliding slot 12 away from the fixed jaw 11. An extension of the interface traverses the restricting recess B. The first slot 121 communicates the jaw opening and the second slot 122.

In view of the sliding portion, the sliding portion includes a first sliding element 221, a second sliding element 222, and a third sliding element 223. The first sliding element 221 has a first end 221a and a second end 221b. The second sliding element 222 is located on a bottom of the first sliding element 221 near the first end 221a of the first sliding element 221. The second sliding element has a third end 222a and a fourth end 222b. An angle between the sliding axis A and the fourth end 222b of the second sliding element 222 is equal to or larger than 90 degrees. In the major embodiment, a bottom face of the first sliding element 221 extends parallelly to the first direction, and a terminal surface of the fourth end 222b of the second sliding element 222 is perpendicular to the first direction. In other words, an angle between the terminal surface of the fourth end 222b of the second sliding element 222 and the sliding axis A is 90 degrees. The third sliding element 223 is located on the bottom of the first sliding element 221 near the second end 221b of the first sliding element 221, wherein an angle between a terminal surface of an end of the third sliding element 223 near the second sliding element 222 and the sliding axis A is equal to or larger than 90 degrees. More preferably, the terminal surface of an end of the third sliding element 223 near the second sliding element 222 is perpendicular to the first sliding element 221. That is, an angle between the terminal surface of an end of the third sliding element 223 near the second sliding element 222 and the sliding axis A is 90 degrees.

The restricting recess B is defined by part of the bottom of the first sliding element 221, the fourth end 222b of the second sliding element 222, and the end of the third sliding element 223 near the second sliding element 222. More preferably, a contour of the first sliding element 221 corresponds to the first slot 121, and contours of the second sliding element 222 and the third sliding element 223 correspond to the second slot 122 respectively. Thus, the first sliding element 221 has a width smaller than widths of the second sliding element 222 and the third sliding element 223, and the width of the second sliding element 222 is equal to the width of the third sliding element 223. When the sliding portion is slidably disposed in the sliding slot 12, the first sliding element 221 is located in the first slot 121, and the second and the third sliding elements 222,223 are located in the second slot 122 respectively. In addition, the jaw portion forms a receiving groove 222c located outside a range which a width of an opening of the restricting recess B extends along a second direction. The second direction is substantially perpendicular to the first direction. More preferably, the receiving groove 222c is formed on the sliding portion, more specifically on the second sliding element 222.

The elastic element 4 is disposed in the receiving groove 222c. A fifth end of the elastic element 4 is connected with the main body 1 via the abutting element 3, and a sixth end of the elastic element 4 abuts against a side wall of the receiving groove 222c. More specifically, a protrusion 224 is formed from the side wall of the receiving groove 222c along the first direction, and the sixth end of the elastic element 4 is sleeved onto the protrusion 224. The abutting element 3 is inserted through the main body 1 and the receiving groove 222c. The fifth end of the elastic element 4 abuts against an end of the abutting element 3 near the third end 222a of the second sliding element 222, and the sixth end of the elastic element 4 abuts against a side wall of the receiving groove 222c near the third end 222a of the second sliding element 222. More preferably, the abutting element 3 is rod-shaped, and the sliding axis A traverses an axis of the abutting element 3. Moreover, the receiving groove 222c extends along the first direction and defines a central axis traversing a center between two ends of an extending direction of the receiving groove 222c. Also, the central axis traverses the axis of the abutting element. In other words, the central axis overlaps the sliding axis A.

The handle 5 is rotatably disposed on the main body 1. A first side face 51 and a second side face 52 are formed at two sides of the handle 5 in a width direction. The width direction of the handle 5 is parallel to the first direction. A toggle element 53 is disposed at an end of the handle 5 and extends into the restricting recess B, and an extension of the interface traverses the toggle element 53, as shown in FIG. 3. The toggle element 53 has first propping face 531 and second propping face 532 wherein the second propping face 532 extends from the first side face 51 inward and obliquely. The handle 5 is pivot between a driving position and a release position. In the major embodiment, the toggle element 53 is formed protrusively from an end of the handle 5, and the handle 5 forms an aperture 54 at an end. During assembling, the toggle element 53 is directly inserted into the trough. The main body 1 further includes a pin 15 inserted through the through hole 13 of the main body 1 and the aperture 54 of the handle 5 so that the handle 5 is able to pivot around the pin 15 between the driving position and the release position. Besides, the through hole 13 is perpendicular to the sliding slot 12 so that an extending direction of the pin 15 is perpendicular to the first direction.

Pleaser refer to the FIG. 3, when the wrench of the present invention is employed to turn a nut 6, the handle 5 should be pulled counterclockwise first. When the handle 5 is located at the driving position, the first propping face 531 of the toggle element 53 abuts against the fourth end 222b of the second sliding element 222, and the extension of the interface traverses the toggle element 53 so that the jaw opening can be retained at a minimum size. Thereby, the movable jaw 2 and the fixed jaw 11 is able to clamp on two sides of the nut 6, and the handle 5 can be pulled clockwise continuously to loosen or fasten the nut 6. On the other hand, if the restricting recess B further extends toward the first sliding element 221, the first propping face 531 may abut against the first sliding element 221 too.

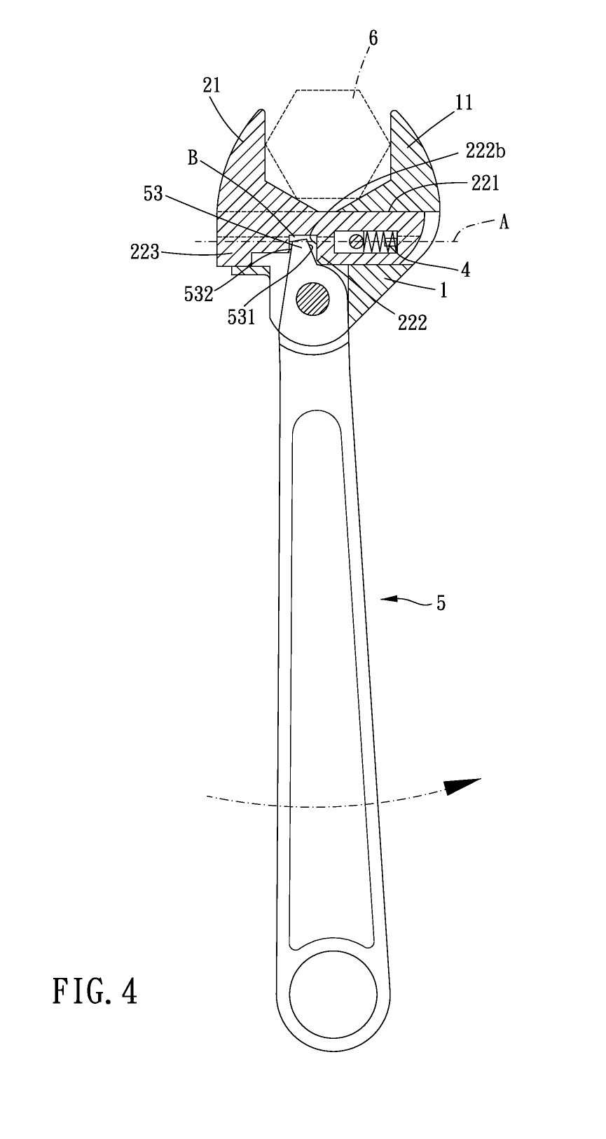

Please refer to FIG. 4, when the handle 5 is pulled counterclockwise to the release position, the first propping face 531 of the toggle element 53 is away from the second end 222b of the second sliding element 222, and the second propping face 532 of the toggle element 53 abuts against an end of the third sliding element. In addition, the extension of the interface still traverses the toggle element 53 so that the movable jaw 21 is able to move away from the fixed jaw 11 to enlarge the jaw opening. Thereby, the wrench of the present invention is able to be rotated relative to the nut 6 until the other two sides of the nut 6 are clamped by the wrench of the present invention. The elastic element 4 provides an elastic force to the movable jaw 11 so that the movable jaw has a tendency to move toward the fixed jaw 11 to reduce the size of the jaw opening to clamp on the nut 6.

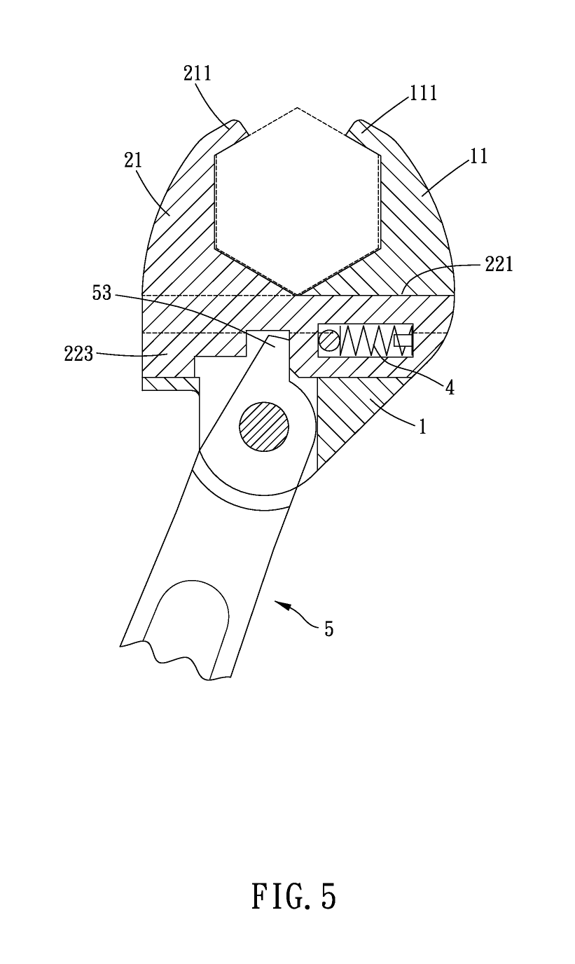

Please refer to FIG. 5 for a second embodiment of the present invention. A difference from the first embodiment is that tops of the fixed jaw 11 and the movable jaw 21 extend obliquely to form jaw extensions 111,211 respectively.

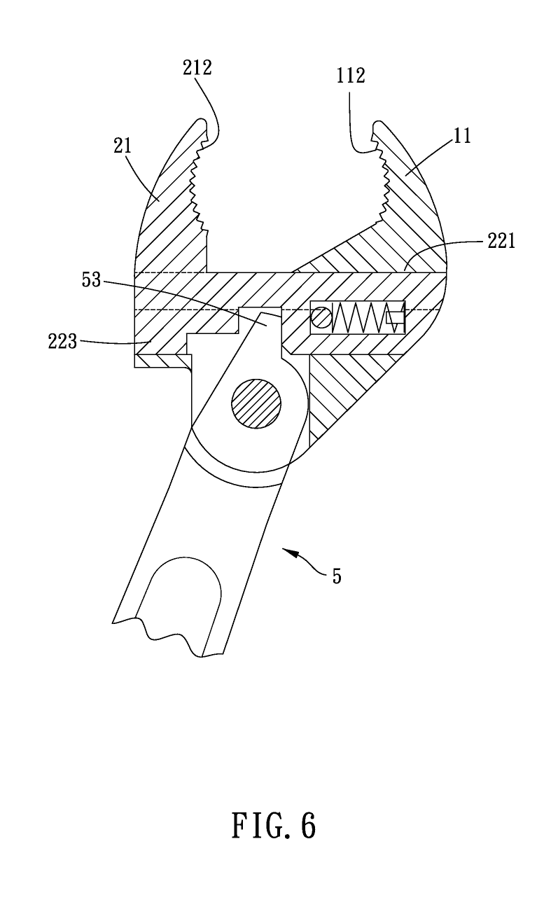

Please refer to FIG. 6 for a third embodiment of the present invention. A difference from the first embodiment is that the fixed jaw 11 and the movable jaw 21 form recess faces facing each other. More preferably, the recess faces form a plurality of teeth 112,212 respectively.

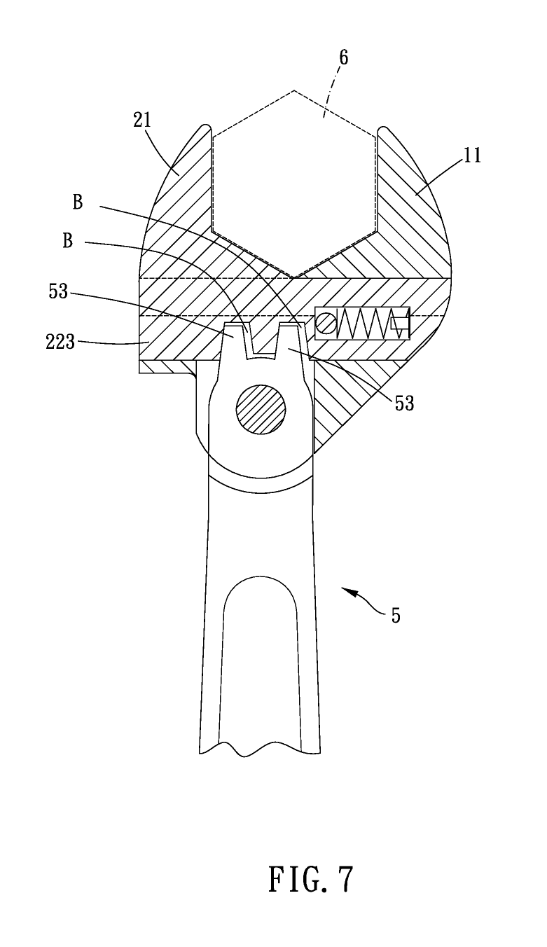

Please refer to FIG. 7 for a fourth embodiment of the present invention. A difference from the first embodiment is that the sliding portion forms two restricting recesses B, and two toggle elements 53 are disposed at an end of the handle and extend into the two restricting recesses B respectively.

In conclusion, as a result of that the extension of the interface traverses the toggle element 53 when the toggle element 53 abuts against the second sliding element 222, force exerted by a user is transmitted completely to the second sliding element 222 horizontally and further to the abutting element 3 without any component of force. Thereby, force exerted by a user can be fully transmitted to the movable jaw 21 and the fixed jaw 11. More specifically, when the sliding axis A overlaps the central axis of the receiving groove 222c and traverses the axis of the abutting element 3, force can be completely transmitted.

Similarly, when the toggle element 53 abuts against the third sliding element 223, the extension of the interface traverses the toggle element 53 so that force can be fully transmitted to the third sliding element 223 horizontally. Thereby, the jaw portion 2 can be easily pushed by the toggle element 52 away from the fixed jaw 11. More specifically, the sliding axis A also traverses the toggle element so that force is able to be completely transmitted.

Furthermore, the terminal face of the fourth end 222b of the second sliding element 222 is perpendicular to the first sliding element 221, and the terminal face of the end of the third sliding element 223 near the second sliding element 222 is perpendicular to the first sliding element 221 too. Hence, the first propping face 531 abuts against the terminal face of the fourth end 222b of the second sliding element 222 by face contacting, and the second propping face 532 also abuts against the terminal face of the end of the third sliding element 223 by face contacting. Thereby, force can be transmitted to the second sliding element 222 or the third sliding element 223 to improve the durability of the toggle element.

Besides, the present invention has a simple structure. The wrench of the present invention can be adapted for clamping a nut or other similar objects by pulling the handle to drive the toggle element 53 to abut against the fourth end 222b of the second sliding element 222. Thus, manufacturing is simplified, and cost is reduced. More importantly, problems due to engagement of teeth can be avoided.

What is claimed is:

1. A wrench, comprising:
a main body, formed in one piece and forming a fixed jaw, the main body forming a sliding slot along a first direction, the first direction being substantially perpendicular to an extending direction of the fixed jaw;
a jaw portion, a movable jaw being integrally formed at an end of the jaw portion, a sliding portion being formed at a bottom of the movable jaw, the sliding portion forming at least one restricting recess, the sliding portion being slidably disposed in the sliding slot, a jaw opening being defined between the movable jaw and the fixed jaw, an interface being defined by a contact surface between a bottom of the sliding portion and a bottom surface of the sliding slot away from the fixed jaw, an extension of the interface traversing the restricting recess;
a handle, rotatably disposed on the main body, at least one toggle element being formed at an end of the handle, the toggle element extending into the restricting recess, the handle being able to pivot between a driving position and a release position, the toggle element abutting against the sliding portion to retain the jaw opening in a minimum size when the handle is at the driving position, the movable jaw being able to move away from the fixed jaw to enlarge the jaw opening; and
an elastic element, disposed between the main body and the jaw portion to provide elastic force so that the movable jaw tends to move toward the fixed jaw.

2. The wrench of claim 1, wherein the sliding slot including a first slot and a second slot, the first slot communicates the jaw opening and the second slot, the sliding portion includes a first sliding element and a second sliding element, the first sliding element has a first end and a second end, the second sliding element is located at a bottom of the first sliding element and is close to the first end of the first sliding element, the second sliding element has a third end and a fourth end, the first sliding element and the second sliding element are received in the first slot and the second slot respectively when the sliding portion is disposed in the sliding slot.

3. The wrench of claim 2, wherein the sliding portion includes a third sliding element, the third sliding element is located at a bottom of the first sliding element and is close to the second end of the first sliding element, the toggle element abuts against an end of the third sliding element to drive the movable jaw to move away from the fixed jaw when the handle is at the release position.

4. The wrench of claim 1, wherein the jaw portion forms a receiving groove, the receiving groove is located outside of an extending range of a width of a notch opening of the restricting recess, the second direction is substantially perpendicular to the first direction, the elastic element is disposed in the receiving groove, a fifth end of the elastic element is connected with the main body by an abutting element, a sixth end of the elastic element abuts against a side wall of the receiving groove.

5. The wrench of claim 4, wherein the receiving groove is formed at the sliding portion.

6. The wrench of claim 4, wherein a protrusion extending along the first direction is formed on the side wall of the receiving groove, the sixth end of the elastic element is sleeved onto the protrusion.

7. The wrench of claim 1, wherein a sliding axis is defined by an extending direction of the sliding slot, the sliding axis traverses the restricting recess.

8. The wrench of claim 7, wherein a fifth end of the elastic element is connected with the main body by an abutting element, the abutting element is rod-shaped, the sliding axis traverses an axis of the abutting element.

9. The wrench of claim 8, wherein the jaw portion forms a receiving groove, the receiving groove is located outside of an extending range of a width of a notch opening of the restricting recess, the second direction is substantially perpendicular to the first direction, the elastic element is disposed in the receiving groove, a sixth end of the elastic element abuts against a side wall of the receiving groove, the receiving groove extends along the first direction and defines a center axis, the central axis traverses the axis of the abutting element and a center between two ends of the sliding slot along the extending direction of the sliding slot so that the central axis overlaps the sliding axis.

10. The wrench of claim 1, wherein the extension of the interface traverses the toggle element.
